(19) United States
(12) Patent Application Publication
(10) Pub. No.: US 2004/0006594 A1
(43) Pub. Date: Jan. 8, 2004

(54) Data access control techniques using roles and permissions

(75) Inventors: Stephen K. Boyer, San Jose, CA (US); Jeffry J. Grainger, Portola Valley, CA (US); Cecily Anne Snyder, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(73) Assignee: FTF Technologies Inc., Boise, ID

(21) Appl. No.: 10/306,818

(22) Filed: Nov. 26, 2002

Related U.S. Application Data
(60) Provisional application No. 60/333,962, filed on Nov. 27, 2001.

(51) Int. Cl. G06F 15/16

(52) U.S. Cl. 709/204

(57) ABSTRACT

A computer-implemented technique for data access management system and providing access to information associated with legal cases including intellectual property cases. The data access management system allows individuals securing intellectual property rights to share data while ensuring that unauthorized access to data is not permitted. According to an embodiment of the present invention, techniques are provided for customizing data access per the user's needs.

### CROSS-REFERENCES TO RELATED APPLICATIONS

This application incorporates by reference for all of the following applications:

(1) U.S. Provisional Application No. 60/253,360, entitled “Data Processing System for Managing Intellectual Property Assets” filed Nov. 27, 2000, listing Stephen K. Boyer et al. as inventors; and

(2) U.S. Provisional Application No. 60/309,230, entitled “Data Access Control Techniques Using Roles and Permissions” filed Jul. 31, 2001, listing Stephen K. Boyer et al. as inventors.

### BACKGROUND OF THE INVENTION

The present invention relates to data access control techniques and more particularly to techniques for controlling access to electronically stored data and documents associated with legal cases including intellectual property cases.

The patent business is big and is growing fast. Over 300,000 new patent applications were filed in the U.S. Patent and Trademark Office last year, and approximately 2,000,000 new patent applications were filed in the rest of the world's patent offices. Driven by an increase in patent infringement judgments and patent royalty revenues, these numbers are expected to increase 20% per year.

As the demand increases, the importance of providing centralized access to information that eliminates duplication of effort (and saves resources) becomes increasingly important. An important step toward increasing efficiency is to allow for the creation and maintenance of data (including case information, bibliographic data, docketing data, and other types of data or information) in a centralized location (e.g., in one file folder) from where it can be accessed, either locally or remotely, by multiple users of the data. However, the drawback to this is the need to appreciate that not everyone should have access to the same data or even the same degree of access. An important aspect of this is the situation where there is a top-secret project that should only be accessed by those with a need to know or where there is an ethical wall that should prevent a user from seeing particular files. In order to create and maintain a robust on-line data accessing/sharing system, these concerns must be dealt with in a way that enables users to continue to do business in a way that is more efficient and does not compromise the integrity and operation of their business.

Based upon the above, there is a need for techniques for providing secure access to data associated with legal cases.

### BRIEF SUMMARY OF THE INVENTION

Embodiments of the present invention pertain to a data access management system for providing access to information associated with legal cases including intellectual property cases. The data access management system allows individuals securing intellectual property rights to share data while ensuring that unauthorized access to data is not permitted. According to an embodiment of the present invention, techniques are provided for customizing data access per the user's needs.

According to an embodiment of the present invention, techniques are provided for either granting or denying a user's request to access a case data unit and/or to perform operation upon the data and documents stored by the case data unit. In this embodiment, a method includes storing information related to a plurality of intellectual property cases on a computer-readable medium; a computer-implemented method of controlling access to information related to a first intellectual property (IP) case, the method comprising: storing information related to a plurality of intellectual property cases on a computer-readable medium, the plurality of intellectual property cases including the first intellectual property case, wherein for each intellectual property case, the information related to the intellectual property case is stored in a case data unit, wherein the case data unit stores data related to the intellectual property case and one or more documents related to the intellectual property case; receiving a request from a first user to perform an operation on the information related to the first IP case; responsive to receiving the request: determining a first group to which the first user is assigned; determining a second group to which a first case data unit storing information related to the first IP case is assigned; determining one or more roles to which the first user is assigned, the one or more roles being associated with a set of permissions; determining case data unit level access information for the first case data unit; and determining if the first user can perform the operation on the information related to the first IP case based upon the first group to which the first user is assigned, the second group to which the first case data unit is assigned, the set of permissions associated with the one or more roles to which the user is assigned, and the case data unit level access information for the first case data unit.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a distributed system that might incorporate an embodiment of the present invention;

FIG. 2 depicts an example of a simple user interface for specifying permissions for a role according to an embodiment of the present invention;

FIG. 3 shows an embodiment of a group hierarchy according to the present invention;

FIG. 4 shows an example of a hierarchy of groups according to an embodiment of the present invention;

FIG. 5 shows an example of a hierarchy of groups according to an embodiment of the present invention;

FIG. 6 depicts an example of a simple user interface according to an embodiment of the present invention wherein case data units are assigned to a parent group;

FIG. 7 depicts an example of a simple user interface according to an embodiment of the present invention wherein groups are organized in a group hierarchy;

FIG. 8 depicts an example of a simple user interface according to an embodiment of the present invention wherein case data units are directly assigned to the Networking Group;

FIG. 9 is a simplified high-level flowchart depicting a method of a data access technique for the documents of a case data unit according to an embodiment of the present invention that includes roles and permissions, groups, and case data unit level access information; and

FIG. 10 is a simplified high-level flowchart depicting a method of a data access technique for a private folder and its associated documents according to an embodiment of the present invention that includes groups.

### DESCRIPTION OF THE SPECIFIC EMBODIMENTS

The present invention provides techniques for controlling access to data related to intellectual property matters. Various data access control techniques are used by the present invention to control access to the case data and case documents of a given case. Embodiments of the present invention pertain to a data access management system for providing access to information associated with legal cases including intellectual property cases. The data access management system allows individuals securing intellectual property rights to share data while ensuring that unauthorized access to data is not permitted. According to an embodiment of the present invention, techniques are provided for customizing data access per the user's needs.

Embodiments of the present invention may include the assignments of roles and permissions to a user and may further include the assignment of the user to one or more groups. According to further embodiments, cases may be stored as case data units, each case data unit containing the case data and case documents associated with a case. According to further embodiments case data units, like users, may be assigned to one or more groups. According to further embodiment, each case data unit may have case data unit level access information controlling access to operations that users can perform on a case data unit. The following description sets forth embodiments of computer implemented data access control techniques using the aforementioned embodiments as well as others for securing case data. Embodiments of the invention can be applied to various legal fields for securing and managing intellectual property rights and more specifically securing and managing patent rights.

As mentioned above, according to an embodiment of the present invention, data access control techniques are provided for controlling access to information related to intellectual property cases including patent cases, copyright cases, trademark cases, and the like. For convenience, one embodiment of the present invention is described below that provides data access control techniques for patent-related cases. However, it should be apparent that the present invention is not restricted to patent cases. Accordingly, the description of the present invention set forth below is not intended to limit the scope of the present invention in any way. One of ordinary skill in the art would recognize variations, modifications, and alternatives.

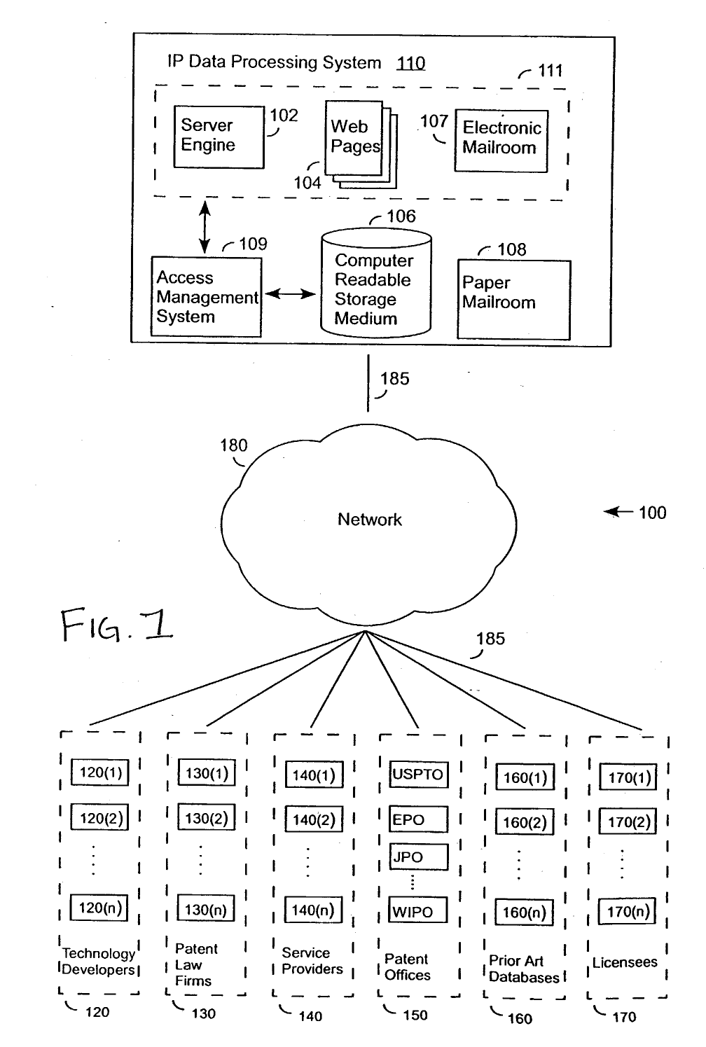

FIG.1 is a simplified block diagram of a distributed system 100 that might incorporate an embodiment of the present invention. As depicted in FIG. 1 distributed system 100 includes an access management system 109 that provides case data unit data access control services according to the teachings of the present invention. According to the embodiment depicted in FIG. 1, the access management system 109 may be part of an intellectual property (IP) data processing system 110 than may be used by participants in the patent process to secure patent rights. According to an embodiment of the present invention, IP data processing system 110 is a Web-enabled electronic platform that can be utilized by all participants in the patent process to convert the traditional paper-based patent prosecution system into an electronic workflow pipeline that allows every step in the process to be executed from a computer desktop.

As depicted in FIG. 1, various other devices or computer systems belonging to participants in the process of securing and/or exploiting patent rights may be coupled to IP data processing system 110 via communications network 180 and communications links 185. These systems include systems of technology developers 120, patent law firms 130, service providers 140, patent offices 150, prior art databases 160, potential licensees 170, and the like. For convenience, each of the participants depicted in FIG. 1 is referenced by a dotted line that encompasses individual entities and the participant type. For example, technology developers 120 are shown in FIG. 1 as including individual technology developers 120(1), 120(2), through 120(n). It is understood that, while shown in FIG. 1 as a group, these multiple technology developers are separate entities that likely have no relation to each other than their classification within this patent application as developers of technology.

It should be apparent that distributed system 100 depicted in FIG. 1 is merely illustrative of an embodiment incorporating the present invention and does not limit the scope of the invention recited in the claims. One of ordinary skill in the art would recognize other variations, modifications, and alternatives. For example, in alternative embodiments of the present invention, access management system 109 may be deployed in various other environments such as an enterprise environment, a stand alone system, and the like.

Communication network 180 provides a mechanism allowing the various devices and computer systems depicted in FIG. 1 to communicate and exchange data and information with each other. Communication network 180 may itself be comprised of many interconnected computer systems and communication links. While in one embodiment, communication network 180 is the Internet, in other embodiments, communication network 180 may be any suitable communication network including a local area network (LAN), a wide area network (WAN), a wireless network, an intranet, a private network, a public network, a switched network, an enterprise network, a virtual private network, and the like. Further, communications network 180 may be a combination of the various types of above-mentioned networks.

Communication links 185 used to connect the various systems depicted in FIG. 1 may be of various types including hardwire links, optical links, satellite or other wireless communications links, wave propagation links, or any other mechanisms for communication of information. Various communication protocols may be used to facilitate communication of information via the communication links. These communication protocols may include TCP/IP, HTTP protocols, extensible markup language (XML), synchronous optical network (SONET) protocols, synchronous digital hierarchy (SDH) protocols, wireless application protocol (WAP), protocols under development by industry standard organizations, vendor-specific protocols, customized protocols, and others.

Technology developers 120 may include corporations, universities, individual inventors, and other like entities seeking to file patent applications and receive issued patents. For example, technology developers may include inventors, in-house patent counsels and patent attorneys, in-house patent administrators, and the like. Patent law firms 130 may include U.S. patent attorneys, patent agents, foreign patent attorneys and/or agents, patent secretaries, docketing personnel in law firms, and other, entities that help technology developers to secure patent rights. Service providers 140 may include patent draftspersons, prior art search companies, translation companies, and other entities that provide services useful to the patent process as well as financial institutions and other parties that have tangential roles in the process. Patent offices 150 may include intellectual property offices and government agencies that are allowed to grant patent rights. These intellectual property offices may includes the USPTO, the European Patent Office (EPO), the Japanese Patent Office (JPO), the Taiwanese Patent Office, etc. Prior art databases 160 may include public and licensed private databases, such as online patent databases (e.g., issued U.S. patents, published European and Japanese patents, etc.) and non-patent databases.

As stated above, access management system 109 provides security services for patent-related cases. According to an embodiment of the present invention, the access management system either allows or disallows various operations to be performed upon case data and case documents associated with a case. According to one embodiment, access management system 109 either allows or disallows users to perform operations upon a case according to rules and permissions assigned to a user, as well as groups assignment of both users and case data units. Other embodiments of the access management system further provide case data unit level access information. These embodiments as well as others are further described in detail below.

As shown in FIG. 1, access management system 109 may be implemented as part of an intellectual property (IP) data processing system 110 that may be used by participants in the patent process to secure patent rights. As shown in FIG. 1, IP data processing system 110 includes a Web server 111, a computer readable storage medium 106, an electronic mailroom 107, and a paper mailroom 108. The computer readable storage medium 106 stores information related to the patent process. For example, the computer readable storage medium 106 may store information pertaining to the technology developers' intellectual property portfolios. Computer readable storage medium 106 may be a variety of devices including but not limited to hard, firm, soft, and optical memory devices. The information in the computer readable storage medium 106 may include drafts and completed invention disclosures, drafts and completed patent application documents, drafts and completed prosecution filings (e.g., amendments), information about discussions pertaining to invention disclosures and patent applications, patent and patent application status information, prior art publications, office actions, assignment papers, other forms and papers filed in or generated by a patent office, etc. According to an embodiment of the present invention, information used by access management system 109 for providing the security services may be stored by computer readable storage medium 106. In alternative embodiment, access management system 109 may also store the information.

Patent process participants (such as technology developer employees and outside law firm personnel) may access the information stored in computer readable storage medium 106 as needed and only to extent that their access rights permit. The information stored in computer readable storage medium 106 may be shared between participants on an as-allowed basis. For example, a technology developer 120 and an appropriate patent law firm(s) 130 servicing the technology developer may share data related to invention disclosures, patent filings, patent prosecution related information and filings, and other like information.

Web server 111 may include a server engine 102 configured to generate and communicate documents including web pages 104 to other systems depicted in FIG. 1. These web pages may be viewed by other systems of the participants depicted in FIG. 1 using a browser application program executing on systems of the participants.

IP data processing system 110 may communicate with patent offices 150 using electronic mailroom 107 and through standard mail (e.g., U.S. Postal Office First Class and Express Mail) using paper mailroom 108. Electronic mailroom 107 may includes a suite of programs that interface to the standards set by each patent office 150. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://nto-ebc.uspto.gov/. Also, in order to track and update status information for pending patent applications, such as Examiner name, assigned art unit and class/subclass, etc., electronic mailroom 107 may have the ability to interface to the USPTO's Patent Application Information Retrieval (PAIR) system using appropriate digital certificates. Electronic mailroom. 107 may also include other programs to interface with other patent offices. The information received from the patent offices by electronic mailroom 107 may be used by the access management system 109 to provide security services for cases and their associated case data and case documents.

Paper mailroom 108 may include printers, fax machines, fax servers and other appropriate equipment for filing patent applications, responses, and other formal papers with the patent offices using standard mailing procedures. Paper mailroom 108 may also include scanners and other equipment that can be used to scan papers and other correspondence received from technology developers 120, patent attorneys 130, and patent offices 150 into computer-readable format. The scanned documents may then be subjected to optical character recognition (OCR) analysis to extract information from the scanned documents. For example, OCR analysis may be used to recognize particular fields from the scanned documents such as title of a patent application, an application number assigned by the USPTO, a patent examiner's name, the type of the document (e.g., an Office Action, a Notice of Allowance, a patent application, etc.), applicant information, assignee information, date of mailing of a correspondence received from a patent office, and other like information. The information extracted from OCR analysis may be stored in computer readable storage medium 106 along with the scanned documents. Alternatively, or in addition to such scanning, personnel in paper mailroom 108 can directly enter appropriate data into computer readable storage medium 106 using computers or data entry terminals coupled to the database through a local area network or similar network. The information extracted from the scanned documents or information entered by personnel in paper mailroom 108 may be used by data access management system 109 to provide security services for cases and their associated case data and case documents.

As described above, in the embodiment depicted in FIG. 1, IP data processing system 100 tracks and records information related to the various patent cases. In alternative embodiments, IP data processing system 100 may track and record information related to other cases such as trademark cases, copyright cases, litigation cases, and the like. According to an embodiment of the present invention, information related to each case is stored in a case data unit. The case may refer to a patent application, a trademark application, a copyright application, a litigation case, and the like. For purposes of the following example, it is assumed that a case refers to a patent-related case, e.g., a patent application, a patent application filed in a particular country or jurisdiction, a patent application filed according to a convention or treaty (e.g., PCT), and the like.

A case data unit stores a data and/or a collection of electronic documents (or references to the electronic documents) that are related to a particular case, e.g., a patent application in a particular country. The electronic documents may include scanned copies of paper documents related to the particular case. For example, the electronic documents stored or referred to by the case data unit may include a scanned copy of an Office Action received from the USPTO. In some instances a patent case may actually include more than one patent application, for example, where a Continued Prosecution Application (CPA) is filed in the USPTO under rule 37 C.F.R. 1.53(d).

The case data unit may be implemented as a data structure, a file, a database, or any other structure capable of storing data and/or documents. In one embodiment, the data stored by a case data unit includes a variety of bibliographic information (referred to herein as “case meta data”) associated with a patent case, as well as one or more documents related to the patent case. Case meta data stored in the case data unit for a particular case may include, for example, a case title, a patent application number (serial number), a filing date, a patent number, a patent date, publication numbers and associated publication dates, a client reference number, a law firm reference number, the country the application is filed in, a list of inventors, a status indicator (e.g., patent application filed, issued, abandoned, etc.), an assignee, information related to the assignment (e.g., an assignment recordation date and reel and frame number), a responsible patent practitioner, a working attorney, priority information (e.g., serial numbers, filing dates and countries of any parent cases), etc.

The documents stored in or referred to by a case data unit may include a variety of documents of different document types. Specific examples of document types include an invention disclosure, a filed patent application, patent drawings, old versions of patent applications and drawings, other patent papers (e.g., other documents filed in, the patent office including Responses to Office Actions, Information Disclosure Statements, Petitions, etc.); forms, image files (e.g., locked documents of .pdf or a similar type of image file format corresponding to a granted patent (if a patent was granted for the case) as well as electronic scanned copies of any office actions received, responses filed in the patent office, filing receipts, etc., received during prosecution of the patent application, notes (e.g., practitioner notes, inventor notes, notes from other interested parties regarding the importance of the patent to a company's business, products or competitor's business or products, etc.), mail (e.g., email messages or alerts), and prior art references among others. It is to be understood that this list is for illustrative purposes only and various embodiments of the invention can include more or fewer document types and information as appropriate.

Each document stored in a case data unit also includes appropriate document meta-data that identifies the document and its history. Examples of document meta-data include document ID, document type, originator, status, security profile, file format, creation date, last modified date, last modified by, physical file attributes, search field key words, completion date, witness names and dates, etc. The combination of a document, its document meta-data and other information related to the document may be referred to herein as a document entity.

According to an embodiment of the present invention, multiple users are allowed to access and share data stored by the case data unit for a case. As previously discussed, the data may be used by the users to collaborate on-line in the creation of intellectual property rights, primarily patent rights, and other legal rights. As can be seen from FIG. 1, several entities may need to access data stored in a case data unit for a particular case.

For example, where a company uses the present invention to manage its patent portfolio, the company will have persons of different levels throughout the organization that may need access to case data unit data for a particular patent application or file. These persons may include persons in the legal department who maintain the file, one or more inventor(s) who created or drafted the invention disclosure(s), the patent coordinator for the business unit that makes the decision on whether or not to file the invention, and others. Further, the degree of access to the case data unit is not the same for each of these persons. For example, a company's would allow an inventor access to disclosures but would not want the inventor to have access to an application. Further, a company's patent coordinator may have access to correspondences with an outside law firm that is prosecuting a case but the patent coordinator would not have access to an application. Other examples for which the degree of access to the case data maybe restricted to a limited number of users include a company's files which are in the process of negotiations such that only persons with a need to know should have access to the file (to prevent inappropriate information dissemination which may expose the company to liabilities e.g., insider trading).

If a company uses an outside law firm to handle one or more cases, the company may want to grant the law firm personal access to the case data units. However, within the law firm there may be persons who for an ethical reason may not to have access to the case data unit data (e.g., because a person worked for a competitor or for a party adverse to the company).

The case data unit provides the logical centralization of data. Because the case data unit is an information hub designed to be accessed by many persons/users from both within a company and outside the company, controlling access to the data stored in the case data unit is of paramount importance. According to an embodiment of the present invention, several data access techniques are provided that control and/or regulate access to information stored by the case data unit. According to the teachings of the present invention, the data access techniques determine who can access the data stored in a particular case data unit and the extent of the data access. According to an embodiment of the present invention, the degree of access to the data is measured by access to a case data unit and is further measured by the operations that can be performed on the data by permitted users. Accordingly, the data access techniques of the present invention control whether or not a user can access a case data unit and whether or not the user can perform operations on documents stored in a stored by a case data unit.

According to an embodiment of the present invention, three different data access techniques are provided to control access to data stored in case data units. These techniques include (a) the use of roles and permissions; (b) the use of groups; and (c) access control techniques associated with each individual case data unit referred to as case data unit level access information. Each of these data access control techniques are described below in further detail. It should be apparent that in alternative embodiments of the present invention, other data access control techniques may also be used.

As described above, a case data unit may store one or more documents (or references to one or more documents) related to a particular case. Each document may be classified as belonging to a particular type. Examples of documents types include patent applications, office action, the responses to office action, issued patents, and the like. According to an embodiment of the present invention, roles and permissions are used to control operations that may be performed on documents of a particular type.

According to an embodiment of the present invention, each user who wishes to share and/or access information stored by IP data processing system 110 shown in FIG. 1 is assigned to one or more roles. Examples of roles include practitioners such as patent attorneys, patent agents, foreign patent attorneys dealing with patent cases, foreign patent agents, responsible partner attorney, working attorney, or any other individuals authorized to represent a client in legal cases including intellectual property cases. Other examples of roles include, a system administrator who maintains computer systems or computer networks upon which embodiments the present invention may run, a docketing administrator, an inventor, a patent examiner working for a patent office, and the like. For example, a user named “Jane Wright” may be assigned to the role of working attorney.

One or more permissions may be associated with each role. Each permission defines a degree of data access by a person assigned to the role with which the permission is associated. According to an embodiment of the present invention, a permission associated with a role identifies an operation that can (or cannot) be performed by a person assigned to the role on data or documents of a particular type. Types of operations may include creating a document, viewing a document, modifying a document, deleting a document, printing a document, and the like.

According to an embodiment of the present invention, each user assigned to a role is automatically assigned a set of permissions associated with the role. However, if the set permissions automatically assigned are not adequate for a given user the permissions assigned to a role may be customized. Additional permissions may be added to the set of permissions automatically assigned to a role. Moreover, if the default permissions are too broad for a given user, permissions can be removed from the set permissions of permissions automatically assigned to a role.

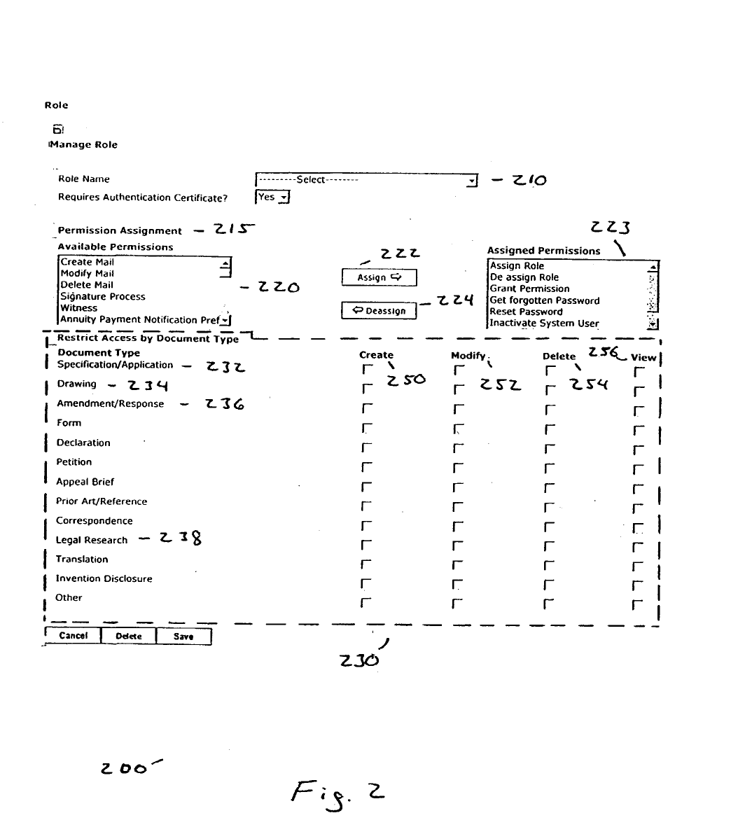

FIG. 2 depicts an example of a simple user interface 200 for specifying permissions for a role according to an embodiment of the present invention. User interface 200 depicted in FIG. 2 is merely illustrative of an embodiment of the present invention and does not limit the scope of the invention as recited in the claims. One of ordinary skill in the art would recognize other variations, modifications, and alternatives. User interface 200 may be used by a person such as a system administrator who is in charge of controlling access to data stored by IP data processing system 110 as shown in FIG. 1.

As depicted in FIG. 2, the role for which permissions are to be assigned may be specified in field 210. A drop-down menu is provided to select a particular role from pre-configured roles. Various roles assignable to a user may include but are not limited to, system administrator, docketing administrator, inventor, responsible attorney, working attorney, and others. Each role has associated with it a set of permissions. A user assigned a given role is also assigned the permissions associated with the role.

Several pre-configured permissions are listed in field 220. In addition to the default permissions, one or more additional permissions from field 220 may be assigned to the role specified in field 210. By selecting the permissions using an input device such as a mouse and by selecting “Assign” button 222 selected permissions in field 220 are assigned to the role. A list of permissions assigned to the role is listed in field 223. A previously assigned permission may be deasigned by selecting the permission in field 223 and selecting “Deassign” button 224.

Examples of permissions include viewing documents, creating, modifying, and deleting applications, creating, modifying, and deleting mail associated with a case, printing document, and the permission to purge the case of other unwanted documents such as rough drafts. For example a user assigned the role of patent agent may have all the permissions listed above, but might not have permission to modify docketing data, which would be accessed through the docketing administrator.

According to another embodiment of the present invention, several permissions may be variably to particular document types. An embodiment of the present invention shown in the example of FIG. 2 depicts permissions and various document types in section 230. Depicted permissions include create 250, modify 252, delete 254, and view 256. Other permission such as print, copy, and the like may also be included. The example depicted in FIG. 2 shows the different document types to include Specification/Application 232, Drawing 234, and Amendment/Response 236 among others. Once these permissions are assigned to a particular document type the user will have permission to perform the designated operations on the particular document type. For example, the user “Jeff Grainger” assigned to the role of working attorney may be assigned all categories of operations (create, modify, delete, and view) upon all the document types. However, not all users should be given such broad access to the data stored in a case data unit. For example, a user “John William” assigned to the role paralegal role may be given access only to documents of type legal research 238. Further, the user John William may be limited only to the operations of viewing and creating legal research documents, while not being allowed to modify or delete a legal research document.

The permissions associated with roles and assigned to users apply uniformly to all case data units a user is given access to. However, user assignment to a role and it associated permissions does not provide the user access to a case data unit. According to an embodiment of the invention, the group access control mechanism is used to grant users access to case data units representing specific cases. A user may gains access to case data unit by being assigned to a group(s). Each group having assigned users is also assigned cases having associated case data units. According to yet a further embodiment, a user may gain access to case data unit the appropriate case data unit level access information. Each case data unit has associated with it case data unit level access information. Groups and case data unit level access information are discussed in further detail below.

According to an embodiment of the present invention, data access techniques include the utilization of group hierarchies and the assignment of cases and users to groups within the hierarchy. According to an embodiment of the present invention, a user will have access to a case data unit if the user and case data units are assigned to the same group. According to another embodiment, a user will have access to a case data unit if the user's assigned group contains the group to which the case data unit is assigned. The groups to which users and cases are assigned may be structured hierarchically. Group assignment is discussed in further detail below.

Various group hierarchies can be implemented to control user access to case data units. FIG. 3 shows a group hierarchy 300 according to an embodiment of the present invention. Group 310 of the hierarchy is said to contain groups 315 and 320. Further, group 315 is said to contain and groups 325, 330, and 335. Further, group 315 is said to contain groups 325, 330, and 335. Thus, group 310 can be considered to contain groups 325, 330, and 335. Cases may be assigned to a group (e.g., group 335) or a set of groups (e.g., groups 325 and 330). For example, while case 365 is assigned to group 325, case 370 is assigned to both groups 325 and 330. However, case 370 need not be assigned to group 335. Thus, if a user is assigned to group 335 and not to groups 310, 315, 325, or 330, the user will not be allowed access to case 370 and accordingly will not be allowed to perform operations on the case data unit associated with case 370. Also, cases may be assigned to a group (e.g., group 310) that contains other groups (e.g., 315 and 320). If a case is assigned to a group that contains other groups, the case is said to be assigned to both the group containing the other groups and to the contained groups. For example, case data unit 350 assigned to group 310 is said to be assigned to groups 315 and 320 contained by group 310.

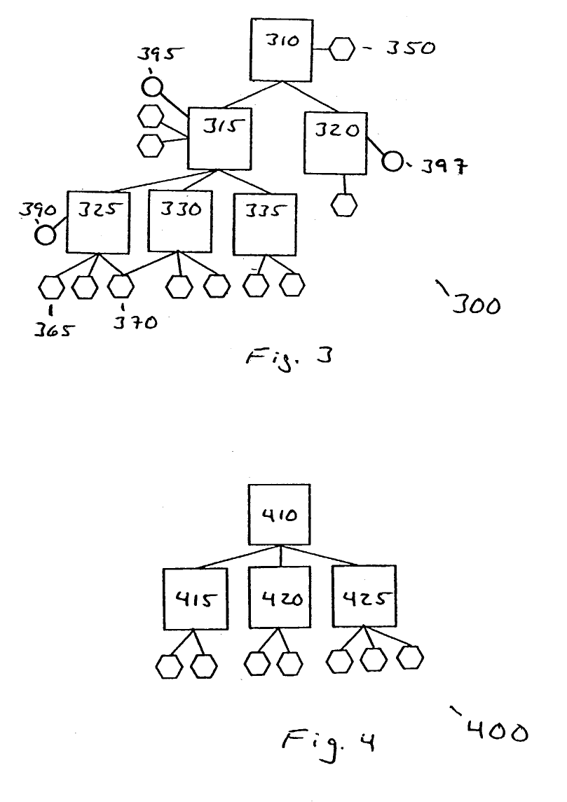

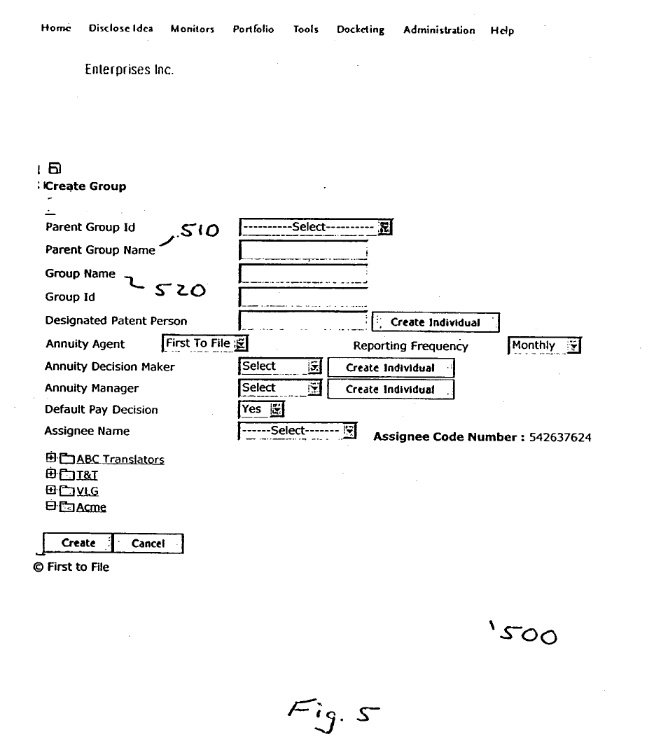

According to another embodiment of the invention, a group hierarchy may be include two sets of groups. For convenience the two sets of groups are referred to as a first set of group and a second set of groups. A group of the first set of groups may or may not contain one or more groups of the second set of groups. According to one embodiment, cases may be assigned to either groups of the first or second set of groups. According to another embodiment cases may be assigned to groups of the second set of groups but are not assigned to groups of the first set of groups. FIG. 4 shows an example of a hierarchy of groups 400 having case data units assigned to groups 415, 420, and 425. Groups 415, 420, and 425 are said to be of a second set while group 410 is said to be of a first set. According to another embodiment groups are not in a hierarchy but are limited to groups that do not contain other groups.

Each of these hierarchies of groups may similarly be described in terms of levels while describing the same functionality as that discussed above. For example, a so-called level zero groups would contain subgroups but would not be contained by other groups. Further, each level of group containment by another group can be labeled/described by the number of groups it is contained by. In the example of FIG. 3, group 310 would be a level zero group, groups 315 and 320 would be level one groups, and groups 325, 330, and 335 would be level two groups. Those of skill in the art will undoubtedly know of other useful group hierarchy and further useful ways of describing such hierarchies.

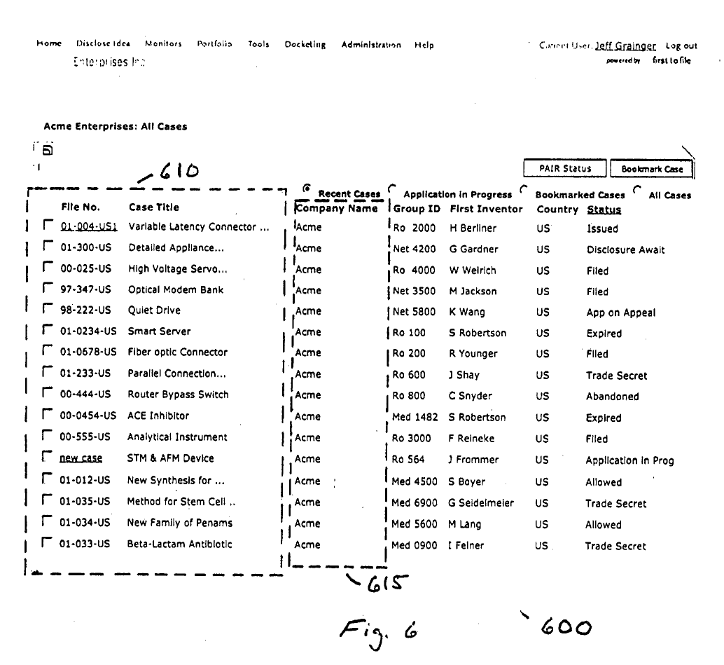

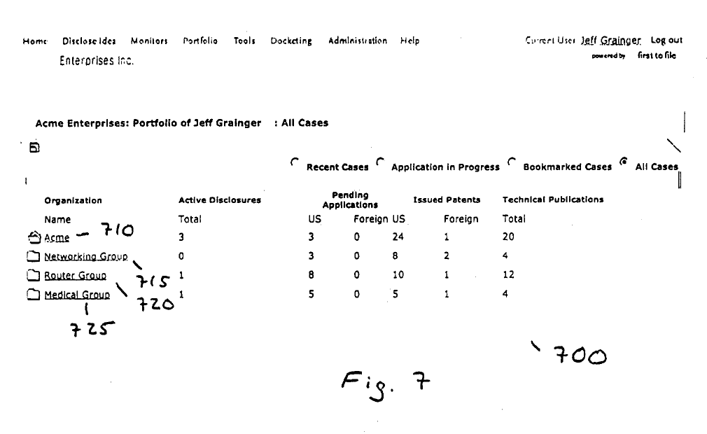

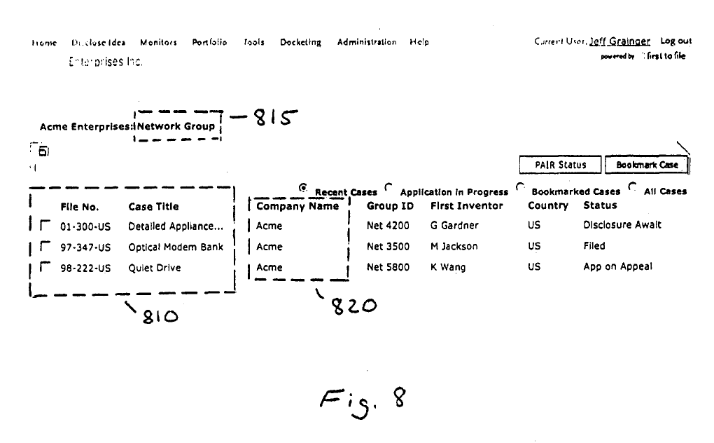

FIG. 5 depicts an example of a simple user interface 500 for creating groups according to an embodiment of the present invention. A parent group name 510 is associated with subgroups 520 having group names. Parent group 510 is said to contain the subgroups 520. Collections of case having associated case data units may be variously assigned to the groups and subgroups. FIG. 6 depicts an example of a simple user interface 600 according to an embodiment of the present invention wherein cases 610 having associated ca data units are assigned to a parent group 615. Cases assignments to a parent group usually follow some logical order, such as case data units associated with a given company or client, or case data units that another law firm has access to. In the example shown in FIG. 6 case data units 610 are assigned to parent group Acme (Acme for example being the company name of a client). FIG. 7 depicts an example of a simple user interface 700 according to an embodiment of the present invention, wherein groups are organized in a group hierarchy. At the top of the hierarchy is the parent group Acme 710. Contained by the parent group Acme are the Networking Group 715, the Router Group 720, and the Medical Group 725. In the example of FIG. 7, cases having associate case data units are assigned to the subordinate groups. For example, FIG. 8 depicts an example of a simple user interface 800 according to an embodiment of the present invention, wherein cases 810 are assigned to the Networking Group 815. Through the direct assignment of case data units 810 to Networking Group 875 case data units 810 are in turn assigned to the parent group Acme 820.

Each of FIGS. 5, 6, 7, and 8 and the various user interfaces depicted are merely illustrative of embodiments of the present invention and do not limit the scope of the invention as recited in the claims. One of ordinary skill in the art would recognize other variations, modifications, and alternatives.

According to one embodiment of the present invention, users access case data units through group assignment. A user assigned to a group will have access to the case data units in the group. Further, a user assigned to a group that contains a group to which a case data unit is assigned will have access to the case data unit. Further, if a user and case data unit are not assigned to the same group or if a user's assigned group does not contain the case data unit's assigned group, the user will not have access to the case data unit.

For example, FIG. 3 shows a user 390 assigned to group 325. Moreover, cases data units 365 and 370 belong to the group 325. As user 390 and case data units 365 and 370 belong to the group 325, accordingly user 390 will have access to these case data unit 365 and 370. According to a further example, FIG. 3 shows user 395 assigned to group 315. Group 315 contains the groups 325, 330, and 335. Case 365 having an case data unit is assigned to group 365. As user 395 is assigned to a group 315 that contains group 325, accordingly user 395 will have access to the case data units belonging to group 325. According to a further example, FIG. 3 shows user 397 assigned to group 320. As group 320 has not been assigned case 365 and its associated case data unit and as group 320 does not contain a group that contains case 365, accordingly user 397 will not have access to case 365 and its associated case data unit.

According to an embodiment of the present invention, users can automatically be assigned to groups based upon their assigned roles. According to another embodiment, a user can manually be assigned to a group. For example, for a top-secret file for which access is limited manual addition of users to groups is preferred to automatic assignment based upon roles.

A user assigned to a group brings with them the permissions associated with their assigned role. Similarly stated, assignment to a group while allowing access to case data units does not necessarily provide full access to all case data unit data or to access operations that can be performed on the data. Thus, the permissions assigned to a user limit the operations a user can perform on the case data units based upon the user's group assignments.

Legal systems have further special needs to protect data and document and thus there is a desire for further special data access techniques. For example, ethical issues arise requiring a person not to come in contact with a client's legal documents or for business reasons the client may want to limit access to legal documents on a need to know basis. These are just a few examples providing impetus for case data unit level access information techniques.

According to one embodiment of the invention, each case data unit has unique case data unit level access information. Case data unit level access information provides that regardless of group assignment, a user can be granted or denied access to a case data unit and/or its associated documents. The case data unit level access information for each case data unit is comprised of an include list and an exclude list. If a user is entered onto the include list for the case data unit level access information of a given case data unit the user is given access to the case data unit and may perform operations upon case data unit and is associated document determinant upon the user's assigned permissions. If however a user is entered onto the exclude list the case data unit level access information of a given case data unit the user is denied access to the case data unit and is associated document. Thus, regardless of whether a user and a case data unit are not assigned to the same group and regardless of whether a user's assigned group does not contain the group to which the case data unit is assigned, the include list of the case data unit level access information overrides the exclusion based on group assignment. And further, regardless of whether a user and the case data unit are assigned to the same group and regardless of whether a user's assigned group contains the group to which the case data unit is assigned, the exclude list of the case data unit level access information overrides the access based on group assignment.

According to one embodiment of the present invention, a user may neither be placed on the include list nor exclude list for the case data unit level access information of a given case data unit. In such a condition, whether a user can perform operations upon a case data unit is determined upon whether the user and case data unit are assigned to the same group or whether the user's assigned group contains the group to which the case data unit is assigned, (described in detail above).

According to another embodiment of the present invention, users can be automatically added to an include or exclude list based upon their role assignment or other rules. Rules may include a combination of logical expressions that either indicate the automatic placement of a user on an include or exclude list. Logical expressions may include compound logical equations that include logical connectors such as, and, and not, or, nor, and the like. For example, a logical expression for automatically placing a user on an include list may be represented by the generic logical equation A or B, and C, and D. Wherein the elements A, B, C, and D may for example include A being a first user role, B being a second user role, C being a given client, and D being a given set of permissions. For example, the first user role may be billing attorney, the second user role may be working attorney, the given client may be Acme, and the given set of permissions being all available permissions. Similar logical equation can be provided for placing a user on an exclude list for the case data unit level access information for a given case data unit. For example, a generic equation may be L or M, and N, and not O. Wherein the elements L, M, N, and O may for example include L being a first client, M being a second client, N being a user who has worked for the first or second client and O being the role of system administrator. Thus, a user “Jane Wright” assigned to the role working attorney (not system administrator), who has worked for the first and second client L and M may be automatically placed on an exclude list for the case data unit level, access information for a case data unit for a client say Acme who is adverse to both L and M.

According to another embodiment of the present invention, users may be manually added to include or exclude lists for case data unit level access information for given case data units. Each of these embodiments provides the special needs of legal systems for limiting or granting access to cases based on ethical issues, business concerns, or other desires.

According to another embodiment of the present invention, the roles and permissions assigned to a user may be overridden by case data unit level access information. The embodiment provides that if a user is placed in the include list for a case data unit, the user is granted all permission related to the case data unit and its associated documents.

According to an embodiment of the present invention, each case data unit has an associated private folder. Private folder may contain information IP data and document related to an IP case the some users want to keep secret from other users of a case data unit. Thus, while some users have access to a given private folders, other users are excluded from accessing the given private folder. Accessibility to a given private folder is controlled by group assignment. If a user and private folders assigned the same group, or if a user's group contains the private folder's group, the user will be able to perform operations upon the private folder and/or its associated documents. For example, a case having an associated case data unit may be assigned to two groups, say group 1 and group 2. However, the private folder associated with the case data may only be assigned to group 1 and not assigned to group 2. Further, a user 1 may be assigned to group 1 while not being assigned to group 2. Further yet, a user 2 may be assigned to group 2 while not being assigned to group 1. Accordingly, as the private folder and user 1 are commonly assigned to group 1, user 1 will be permitted to perform operations upon the private folder and its associated documents. However, while user 2 has access to the case data unit, user 2 does have access private folder because user 2 and the private folder are not assigned to the same group and user 2's group does not contain the group to which the private folder is assigned. But, if user 2 is assigned to a group, say group 3 containing group 1, then user 2 will be permitted to perform operations upon the private folder and its associated documents.

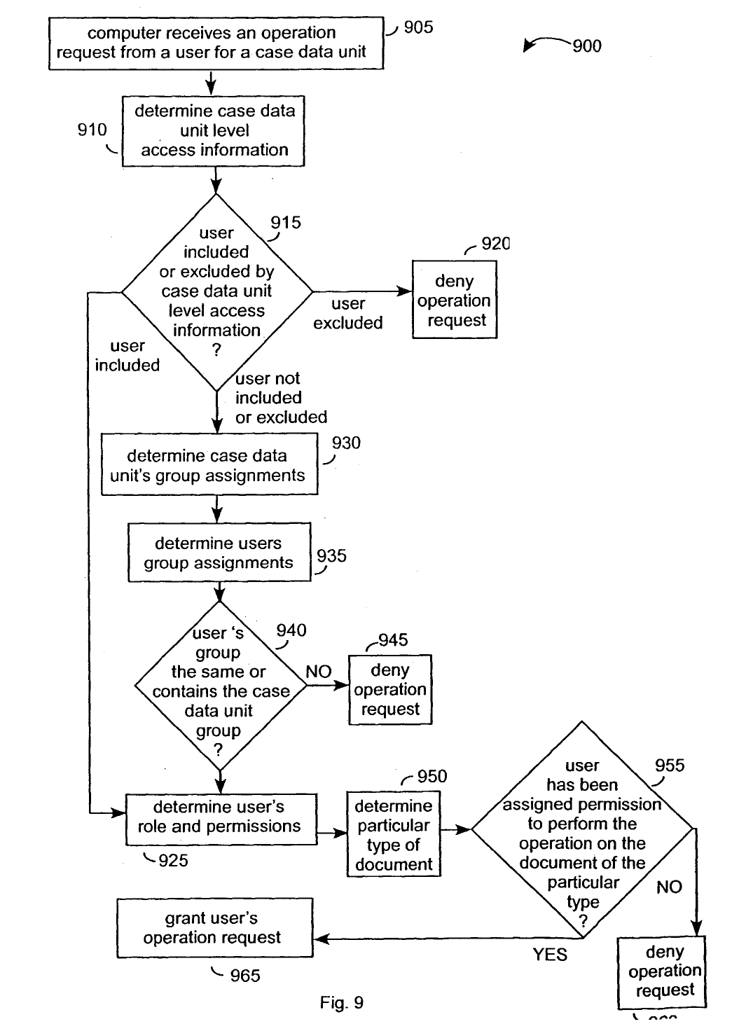

FIG. 9 is a simplified high-level flowchart 900 depicting a method of a data access technique for the data and documents of a case data unit according to an embodiment of the present invention that includes roles and permissions, groups, and case data unit level access information. The method depicted in FIG. 9 may be used to either grant or deny operation requests upon the case data unit and it associated documents. The processing depicted in FIG. 9 is merely illustrative of an embodiment incorporating the present invention and does not limit the scope of the invention recited in the claims. One of ordinary skill in the art would recognize other variations, modification, and alternatives.

The method is initiated by a computer receiving a request from a user to perform an operation on a case data unit and/or the documents of a case data unit 905. The term computer is broadly construed to include several types of computing devices including servers, computer networks, personal computers, hand held devices, or combinations of these as well as other such devices. After receiving the request a determination of the case data unit level access information's include and exclude lists is made 910. Determinant upon the case data unit level access information, the user may be excluded from performing the requested operation, a determination of the user's assigned roles and permission is made, or a determination of the case data unit's group assignment is made 915. Case data unit level access information may specifically exclude a given user from performing any operations on a case data unit and/or its associated documents in which case the operation request is denied 920. Alternatively, case data unit level access information may specifically include the user triggering a determination of the roles and permissions assigned to the user 925. Subsequent to a determination of the roles and permissions assigned to the user 925, a determination of the particular document type the user has requested to perform an operation on is made 950. If the operation requested by the user is not one provided for in the user's assigned permission 955 the operation request is denied 960. Alternatively, if the operation requested is one permitted by the user's assigned permission upon the particular document type 955 the user's operation request is granted 965.

Alternatively, step 915 provides that case data unit level access information may neither exclude nor include the user's operation request in which case a determination of the case data unit's group assignment is made 930. Subsequent to the determination of the group assignment for the case data unit, a determination of the user's group assignment is made 935. One of two possible steps will be taken based upon whether the user and case data unit are assigned to the same group or whether the user's group includes the group to which the case data unit is assigned 940. If the user and case data unit are not assigned to a the same group or if the user's group does not contain the group to which the case data unit is assigned, the user is excluded from performing the requested operation on the case data unit and/or documents of the case data unit 945. However, if the user and case data unit are assigned to the same group or if the user's group contains the case data unit's group, a determination is made of the roles and permissions assigned to the user 925. Subsequent to a determination of the roles and permissions assigned to the user 925, a determination of the particular document type the user has requested to perform an operation on is made 950. If the operation requested by the user is not one provided for in the user's assigned permission 955 the operation request is denied 960. Alternatively, if the operation requested is one permitted by the user's assigned permission upon the particular document type 955 the user's operation request is granted 965.

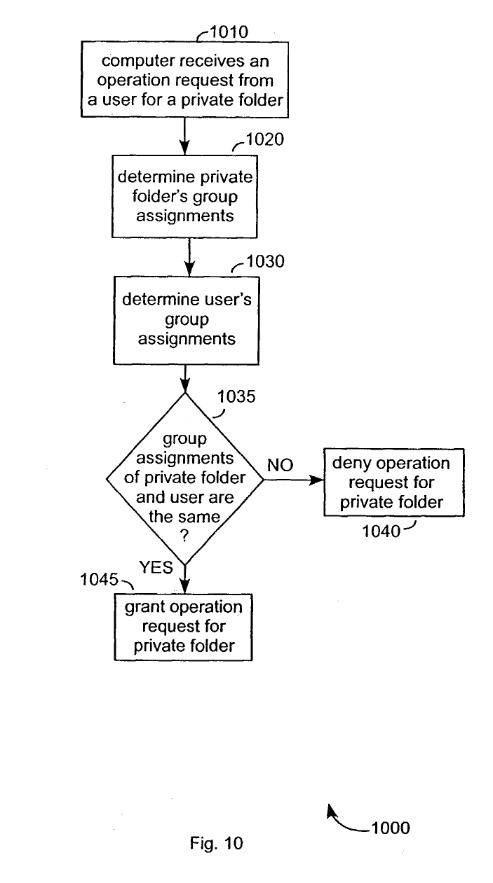

FIG. 10 is a simplified high-level flowchart 1000 depicting a method of a data access technique for a private folder and its associated documents according to an embodiment of the present invention that includes groups. The method depicted in FIG. 10 may be used to either grant or deny operation requests upon the private folder and its associated documents. The processing depicted in FIG. 10 is merely illustrative of an embodiment incorporating the present invention and does not limit the scope of the invention recited in the claims. One of ordinary skill in the art would recognize other variations, modification, and alternatives.

The method is initiated by a computer receiving a request from a user to perform an operation on a case data unit and/or it associated documents 1010. The term computer is broadly construed to include several types of computing devices including servers, computer networks, personal computers, hand held devices, or combinations of these as well as other such devices. Subsequent to the computer receiving the request, the group assignments of the private folder is determined 1020 and the group assignment of the user is determined 1030. One of two possible steps will be taken based upon whether the user and private folder are assigned to the same group or whether the user's group contains the group to which the private folder is assigned 1035. One of the steps is to deny the operation requested upon the private folder and/or its associated documents if the user and private folder are not assigned to the same group or if the user's group does not contain the group to which the private folder is assigned 1040. The other step is to allow the user to perform the operation on the private folder and/or its documents if the user and the private folder are assigned to the same group or the user's group contains the group to which the case data unit is assigned 1045.

While the above is a complete description of specific embodiments of the invention, various modifications, alternative constructions, and equivalents may be used while preserving the fundamental invention of the embodiments. For example, the invention may be implemented in software, firmware, or hardware; the invention may be implemented in a main frame, a personal computer, or a hand held electronic device as well as other devices. Thus, the above description should not be taken as limiting the scope of the invention as defined by the claims.

What is claimed:

1. A computer-implemented method of controlling access to information related to a first intellectual property (IP) case, the method comprising:
storing information related to a plurality of intellectual property cases on a computer-readable medium, the plurality of intellectual property cases including the first intellectual property case, wherein for each intellectual property case, the information related to the intellectual property case is stored in a case data unit, wherein the case data unit stores data related to the intellectual property case and one or more documents related to the intellectual property case;
receiving a request from a first user to perform an operation on the information related to the first IP case;
responsive to receiving the request:
determining a first group to which the first user is assigned;
determining a second group to which a first case data unit storing information related to the first IP case is assigned;
determining one or more roles to which the first user is assigned, the one or more roles being associated with a set of permissions;
determining case data unit level access information for the first case data unit; and
determining if the first user can perform the operation on the information related to the first IP case based upon the first group to which the first user is assigned, the second group to which the first case data unit is assigned, the set of permissions associated with the one or more roles to which the user is assigned, and the case data unit level access information for the first case data unit.

2. The method of claim 1 wherein the plurality of intellectual property cases include patent cases and the first intellectual property case is a patent application case.

3. The method of claim 1 wherein the plurality of intellectual property cases includes trademark cases and copyright cases.

4. The method of claim 1 wherein the set of permission is selected from the group consisting of create, modify, delete, or view.

5. The method of claim 1 wherein the information related to a first intellectual property (IP) case is selected from the group consisting of specification/application, drawing, amendment response, form, declaration, petition, appeal brief, prior art/reference, correspondence, legal research, translation, and invention disclosure.

6. The method of claim 1 wherein the set of permission is selected from the group consisting of create mail, modify mail, delete mail, signature process, witness, annuity payment notification preference, annuity payment instructions, corm annuity payment, modify annuity payment confirmation, export annuity data, import annuity data, create annuity agents, modify annuity agents, delete annuity agents, get status from PAIR, purge case, create invention disclosure, modify invention disclosure, delete invention disclosure, publication, upload invention disclosure, create alert, view alert, setup alert, create case, modify case, delete case, create customer company, modify customer company, delete customer company, create/respond discussion, delete discussion, view discussion, docket, create ad hoc action, de-docket, delete docket, docketing rule, calculate patent term extension, file provisional patent application, file final patent application, create document entity, modify document entity, delete document entity, generate reports, setup automated reporting, internal searching, create URL for external search, modify URL for external search, delete URL for external search, view external URL, create individual, modify individual, delete individual, create entity, modify entity, delete entity.

7. The method of claim 1 wherein the first user can perform the operation on the information related to a first intellectual property (IP) case if the first user is assigned a first permission from the set permissions related to the operation and if the case data unit level access information permits the first user to perform the operation.

8. The method of claim 1 wherein the first user cannot perform the operation on the information related to a first intellectual property (IP) case if the first user is excluded by the case data unit level access information.

9. The method of claim 1 wherein the plurality of groups is organized as a hierarchy such that a group in the plurality of groups may contain one or more other groups in the plurality of groups.

10. The method of claim 1 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

11. The method of claim 1 wherein
if the first user is not excluded by the case data unit level access information from performing the operation on the information related to a first intellectual property (IP) case and is not permitted by the case data unit level access information from performing the operation on the information related to a first intellectual property (IP) case, and
if the set of permissions assigned to the first user does not include a first permission for the operation, then
the operation on the information is not permitted.

12. The method of claim 1 wherein
if the first user is not excluded by the case data unit level access information from performing the operation on the information related to a first intellectual property (IP) case and is not permitted by the case data unit level access information from performing the operation on the information related to a first intellectual property (IP) case, and
if the first group to which the first user is assigned and the second group to which the first case data unit is assigned are not the same group or if first group to which the first user is assigned does not contain the second group to which the first case data unit is assigned, then,
the operation on the information is not permitted.

13. The method of claim 1 wherein
if the first user is not excluded by the case data unit level access information from performing the operation on the information related to a first intellectual property (IP) case and is not permitted by the case data unit level access information from performing the operation on the information related to a first intellectual property (IP case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

14. A computer-implemented method of controlling access to information related to a first intellectual property (IP) case, the method comprising:
storing information related to a plurality of intellectual property cases on a computer-readable medium, the plurality of intellectual property cases including the first intellectual property case, wherein for each intellectual property case, the information related to the intellectual property case is stored in a case data unit, wherein the case data unit stores data related to the intellectual property case and one or more documents related to the intellectual property case;
receiving a request from a first user to perform an operation on the information related to the first IP case;
responsive to receiving the request:
determining a first group to which the first user is assigned;
determining a second group to which a first case data unit storing information related to the first IP case is assigned;
determining one or more roles to which the first user is assigned, the one or more roles being associated with a set of permissions;
determining case data unit level access information for the first case data unit; and
determining if the first user can perform the operation on the information related to the first IP case based the set of permissions associated with the one or more roles to which the user is assigned, and the case data unit level access information for the first case data unit.

15. The method of claim 14 wherein the first user can perform the operation on the information related to a first intellectual property (IP) case if the first user is assigned a first permission from the set permissions related to the operation and if the case data unit level access information permits the first user to perform the operation.

16. The method of claim 14 wherein the first user cannot perform the operation on the information related to a first intellectual property (IP) case if the first user is excluded by the case data unit level access information.

17. A computer-implemented method of controlling access to information related to a first intellectual property (IP) case, the method comprising:
storing information related to a plurality of intellectual property 5 cases on a computer-readable medium, the plurality of intellectual property cases including the first intellectual property case, wherein for each intellectual property case, the information related to the intellectual property case is stored in a case data unit, wherein the case data unit stores data related to the intellectual property case and one or more documents related to the intellectual property case;
receiving a request from a first user to perform an operation on the information related to the first IP case;
responsive to receiving the request:
determining a first group to which the first user is assigned;
determining a second group to which a first case data unit storing information related to the first IP case is assigned;
determining one or more roles to which the first user is assigned, the one or more roles being associated with a set of permissions;
determining case data unit level access information for the first case data unit; and
determining if the first user can perform the operation on the information related to the first IP case based upon the first group to which the first user is assigned, the second group to which the first case data unit is assigned, and the set of permissions associated with the one or more roles to which the user is assigned.

18. The method of claim 17 wherein
if the set of permissions assigned to the first user does not include a first permission for the operation, then
the operation on the information is not permitted.

19. The method of claim 17 wherein
if the first group to which the first user is assigned and the second group to which the first case data unit is assigned are not the same group, or
if first group to which the first user is assigned does not contain the second group to which the first case data unit is assigned, then
the operation on the information is not permitted.

20. The method of claim 17 wherein
if the first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

21. A computer-implemented method of controlling access to information related to a first intellectual property (IP) case, the method comprising:
storing information related to a plurality of intellectual property cases on a computer-readable medium, the plurality of intellectual property cases including the first intellectual property case, wherein for each intellectual property case, the information related to the intellectual property case is stored in a private folder associated with a case data unit, wherein the private folder stores data related to the intellectual property case and one or more documents related to the intellectual property case;
receiving a request from a first user to perform an operation on the information related to the first IP case;
responsive to receiving the request:
determining a first group to which the first user is assigned;
determining a second group to which a first private folder containing information related to the first IP case is assigned; and
determining if the first user can perform the operation on the information related to the first IP case based upon the first group to which the first user is assigned and the second group to which the first private folder is assigned.

22. The method of claim 21 wherein
if the second group to which the first user is assigned and the first group to which the private folder is assigned are the same group, then
the operation on the information related to an intellectual property (IP) case is permitted.

23. The method of claim 21 wherein
if the second group to which the first user is assigned is not the same group to which the private folder is assigned or if the second group to which the first user is assigned does not contain the first group to which the private folder is assigned, then
the operation on the information related to an intellectual property (IP) case is not permitted.

24. A computer program product stored on a computer readable medium for controlling access to information related to a first intellectual property (IP) case, the computer program product comprising:
code for storing information related to a plurality of intellectual property cases on a computer-readable medium, the plurality of intellectual property cases including the first intellectual property case, wherein for each intellectual property case, the information related to the intellectual property-case is stored in a case data unit, wherein the case data unit stores data related to the intellectual property case and one or more documents related to the intellectual property case;
code for receiving a request from a first user to perform an operation on the information related to the first IP case;
code for responsive to receiving the request:
code for determining a first group to which the first user is assigned;
code for determining a second group to which a first case data unit storing information related to the first IP case is assigned;
code for determining one or more roles to which the first user is assigned, the one or more roles being associated with a set of permissions;
code for determining case data unit level access information for the first case data unit; and
code for determining if the first user can perform the operation on the information related to the first IP case based upon the first group to which the first user is assigned, the second group to which the first case data unit is assigned, the set of permissions associated with the one or more roles to which the user is assigned, and the case data unit level access information for the first case data unit.

25. The computer program product of claim 24 wherein the plurality of intellectual property cases include patent cases and the first intellectual property case is a patent application case.

26. The computer program product of claim 24 wherein the plurality of intellectual property cases includes trademark cases and copyright cases.

27. The computer program product of claim 24 wherein the set of permission is selected from the group consisting of create, modify, delete, or view.

28. The computer program product of claim 24 wherein the information related to a first intellectual property (IP) case is selected from the group consisting of specification/application, drawing, amendment response, form, declaration, petition, appeal brief, prior art/reference, correspondence, legal research, translation, and invention disclosure.

29. The computer program product of claim 24 wherein the set of permission is selected from the group consisting of create mail, modify mail, delete mail, signature process, witness, annuity payment notification preference, annuity payment instructions, confirm annuity payment, modify annuity payment confirmation, export annuity data, import annuity data, create annuity agents, modify annuity agents, delete annuity agents, get status from PAIR, purge case, create invention disclosure, modify invention disclosure, delete invention disclosure, publication, upload invention disclosure, create alert, view alert, setup alert, create case, modify case, delete case, create customer company, modify customer company, delete customer company, create/respond discussion, delete discussion, view discussion, docket, create ad hoc action, de-docket, delete docket, docketing rule, calculate patent term extension, file provisional patent application, file final patent application, create document entity, modify document entity, delete document entity, generate reports, setup automated reporting, internal searching, create URL for external search, modify URL for external search, delete URL for external search; view external URL, create individual, modify individual, delete individual, create entity, modify entity, delete entity.

30. The computer program product of claim 24 wherein the first user can perform the operation on the information related to a first intellectual property (IP) case if the first user is assigned a first permission from the set permissions related to the operation and if the case data unit level access information permits the first user to perform the operation.

31. The computer program product of claim 24 wherein the first user cannot perform the operation on the information related to a first intellectual property (IP) case if the first user is excluded by the case data unit level access information.

32. The computer program product of claim 24 wherein the plurality of groups is organized as a hierarchy such that a group in the plurality of groups may contain one or more other groups in the plurality of groups.

33. The computer program product of claim 24 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

34. The computer program product of claim 24 wherein
if the first user is not excluded by the case data unit level access information from performing the operation on the information related to a first intellectual property (IP) case and is not permitted by the case data unit level access information from performing the operation on the information related to a first intellectual property (IP) case, and
if the set of permissions assigned to the first user does not include a first permission for the operation, then
the operation on the information is not permitted.

35. The computer program product of claim 24 wherein
if the first user is not excluded by the case data unit level access information from performing the operation on the information related to a first intellectual property (IP) case and is notpermitted by the case data unit level access
if first group to which the first user is assigned and the second group to which the first case data unit is assigned are not the same group or if first group to which the first user is assigned does not contain the second group to which the first case data unit is assigned, then
the operation on the information is not permitted.

36. The computer program product of claim 24 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

37. A system comprising a processor and a computer readable memory coupled to said processor, said computer-readable memory including computer instructions that:
storing information related to a plurality of intellectual property cases on a computer-readable medium, the plurality of intellectual property cases including the first intellectual property case, wherein for each intellectual property case, the information related to the intellectual property case is stored in a case data unit, wherein the case data unit stores data related to the intellectual property case and one or more documents related to the intellectual property case;
receiving a request from a first user to perform an operation on the information related to the first IP case;
responsive to receiving the request:
determining a first group to which the first user is assigned;
determining a second group to which a first case data unit storing information related to the first IP case is assigned;
determining one or more roles to which the first user is assigned, the one or more roles being associated with a set of permissions;
determining case data unit level access information for the first case data unit; and
determining if the first user can perform the operation on the information related to the first IP case based upon the first group to which the first user is assigned, the second group to which the first case data unit is assigned, the set of permissions associated with the one or more roles to which the user is assigned, and the case data unit level access information for the first case data unit.

38. The system of claim 37 wherein the plurality of intellectual property cases include patent cases and the first intellectual property case is a patent application case.

39. The system of claim 37 wherein the plurality of intellectual property cases includes trademark cases and copyright cases.

40. The system of claim 37 wherein the set of permission is selected from the group consisting of create, modify, delete, or view.

41. The system of claim 37 wherein the information related to a first intellectual property (IP) case is selected from the group consisting of specification/application, drawing, amendment response, form, declaration, petition, appeal brief, prior art/reference, correspondence, legal research, translation, and invention disclosure.

42. The system of claim 37 wherein the set of permission is selected from the group consisting of create mail, modify mail, delete mail, signature process, witness, annuity payment notification preference, annuity payment instructions, confirm annuity payment, modify annuity payment confirmation, export annuity data, import annuity data, create annuity agents, modify annuity agents, delete annuity agents, get status from PAIR, purge case, create invention disclosure, modify invention disclosure, delete invention disclosure, publication, upload invention disclosure, create alert, view alert, setup alert, create case, modify case, delete case, create customer company, modify customer company, delete customer company, create/respond discussion, delete discussion, view discussion, docket, create ad hoc action, de-docket, delete docket, docketing rule, calculate patent term extension, file provisional patent application, file final patent application, create document entity, modify document entity, delete document entity, generate reports, setup automated reporting, internal searching, create URL for external search, modify URL for external search, delete URL for external search, view external URL, create individual, modify individual, delete individual, create entity, modify entity, delete entity.

43. The system of claim 37 wherein the first user can perform the operation on the information related to a first intellectual property (IP) case if the first user is assigned a first permission from the set permissions related to the operation and if the case data unit level access information permits the first user to perform the operation.

44. The system of claim 37 wherein the first user cannot perform the operation on the information related to a first intellectual property (IP) case if the first user is excluded by the case data unit level access information.

45. The system of claim 37 wherein the plurality of groups is organized as a hierarchy such that a group in the plurality of groups may contain one or more other groups in the plurality of groups.

46. The system of claim 37 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.

47. The system of claim 37 wherein
if the first user is not excluded by the case data unit level access information from performing the operation on the information related to a first intellectual property (IP) case and is not permitted by the case data unit level access information from performing the operation on the information related to a first intellectual property (IP) case, and
if the set of permissions assigned to the first user does not include a first permission for the operation, then
the operation on the information is not permitted.

48. The system of claim 37 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are not the same group or if first group to which the first user is assigned does not contain the second group to which the first case data unit is assigned, then
the operation on the information is not permitted.

49. The system of claim 37 wherein
if the first user is not excluded by the case data unit level access information from performing the operation on the information related to a first intellectual property (IP) case and is not permitted by the case data unit level access information from performing the operation on the information related to a first intellectual property (IP) case, and
if first group to which the first user is assigned and the second group to which the first case data unit is assigned are the same group or if first group to which the first user is assigned contains the second group to which the first case data unit is assigned, and
if the set of permissions assigned to the first user includes a first permission for the operation, then
the operations on the information is permitted.
